(19) United States
(12) Patent Application Publication
(10) Pub. No.: US 2009/0193087 A1
(43) Pub. Date: Jul. 30, 2009

(54) System and method for configurable meeting invitation notification on unopened/unaccepted invitations

(76) Inventors: David Lee, Round Rock, TX (US); Teng Hu, Austin, TX (US); Hung T. Dinh, Austin, TX (US); Phong Anh Pham, Austin, TX (US)

Correspondence Address: MAXVALUEIP CONSULTING LLC, 11204 ALBERMYRTLE ROAD, POTOMAC, MD, 20854, US

(21) Appl. No.: 12/020,556

(22) Filed: Jan. 27, 2008

(51) Int. Cl. G06F 15/16

(52) U.S. Cl. 709/206

(57) ABSTRACT

This presentation enhances current meeting/calendar programs, so that the user will receive alerts via cell or regular phone in the event that a user chooses to receive these alerts or is unaware of receiving a meeting invitation via an electronic mail or calendar system. Voice alert can be sent to cell or regular phone, and text alert can also be sent to cell phone. The user can select to get alerts via voice or text to any phone, and can type in the phone number via a configuration tool.

### BACKGROUND OF THE INVENTION

In today's corporate environment there are a number and variety of interactive electronic calendaring systems and methods. The objective of all of these systems is primarily to assist the person who, for a number of different reasons, maintains a calendar of future events that contains various information about the event at entry points on the calendar which relate to the time of the event.

Moreover, in such corporate environment sending and receiving meeting notifications becomes one of most popular routine. Meeting invitations are often part of the calendar components of the e-mail system. Such is the case with IBM's Lotus Notes system and Microsoft's Exchange collaboration packages. The invitation is integrated into the calendar entries of these two popular systems. From time to time one will receive meeting notice and cannot pay attention to it within required time frame. For example, a short meeting notice was sent out last night and the meeting happens early this morning, or a meeting notice is sent while an invitee is on vacation. Another case is when one receives a meeting notice he/she is distracted by other tasks and forget to accept the invitation.

An alternative alert is needed to ensure the invitee is aware of the meeting invitation.

### SUMMARY OF THE INVENTION

One embodiment of the invention provides a solution to resolve the issue. One embodiment of the invention enhances current meeting/calendar programs, so that the user will receive alerts via cell or regular phone in the above described situations. Voice alert can be sent to cell or regular phone, and text alert can also be sent to cell phone.

The program will allow user to configure following items in a calendar entry:

Given that an invitation has not been opened, the user can configure to have an alert. This alert can be configured for any period of time prior to the meeting.

Given that a meeting invitation has been opened but not accepted nor declined, the user can choose to have alert. This alert can be configured for any period of time prior to the meeting. The user can select to get alerts via voice or text to any phone, and can type in the phone number.

### BRIEF DESCRIPTION OF THE DRAWINGS

FIG. 1 is a schematic diagram of the system in its entirety.

FIG. 2 is a schematic diagram of the system and various alerts that can be sent to the user based on predefined configurable criteria.

### DETAILED DESCRIPTION OF THE PREFERRED EMBODIMENTS

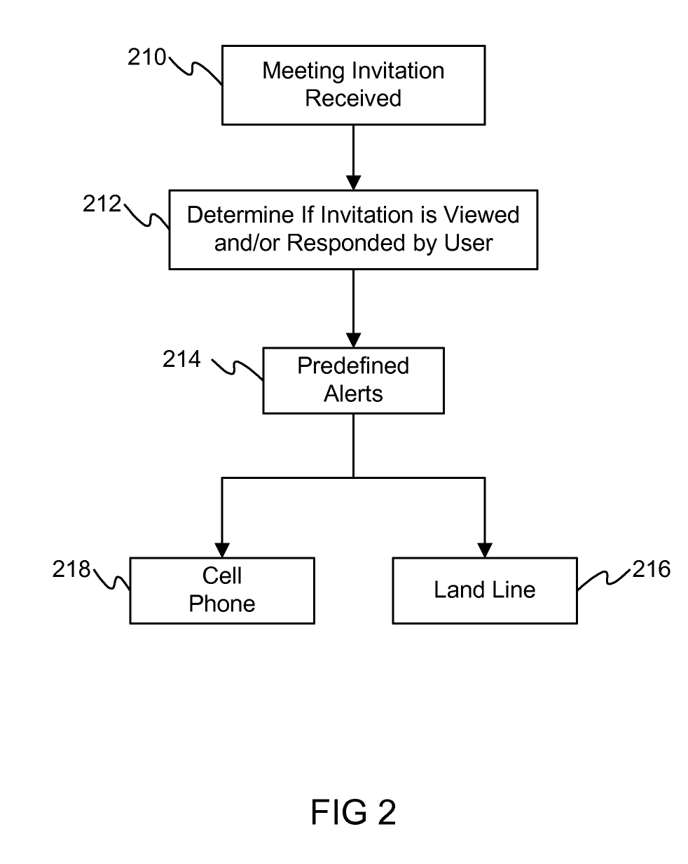

One embodiment of the invention relates to a system of sending alerts based on a plurality of calendars being maintained on an information processing system. One embodiment of the invention enables an end user who maintains a calendar on the information processing system to schedule a meeting or receive an invitation on the system for a meeting. The user sends each of the invitees a meeting notice or receives a meeting notice from others in form of a meeting notification. The invitation remains in the calendar entry of the system until the user takes an action. Should the user decide not to take an action or is unaware of such an entry predetermined alerts are sent (FIG. 2). A log is maintained of each entry or attempted entry and its associated status for the user.

A configuration tool in the program allows user to enter configuration information, the information can then be saved to a data file. As part of the program, an agent will keep track of each meeting invitation, a not opened flag is set to true initially for any meeting invitation. If the meeting invitation is opened before meeting time then the flag is set to false. By the time an alert is set to be sent, the agent will check for this flag, if flag is still true it will send the alert. Similar solution can be provided for other situations:

Collaboration and Applications

Calendar

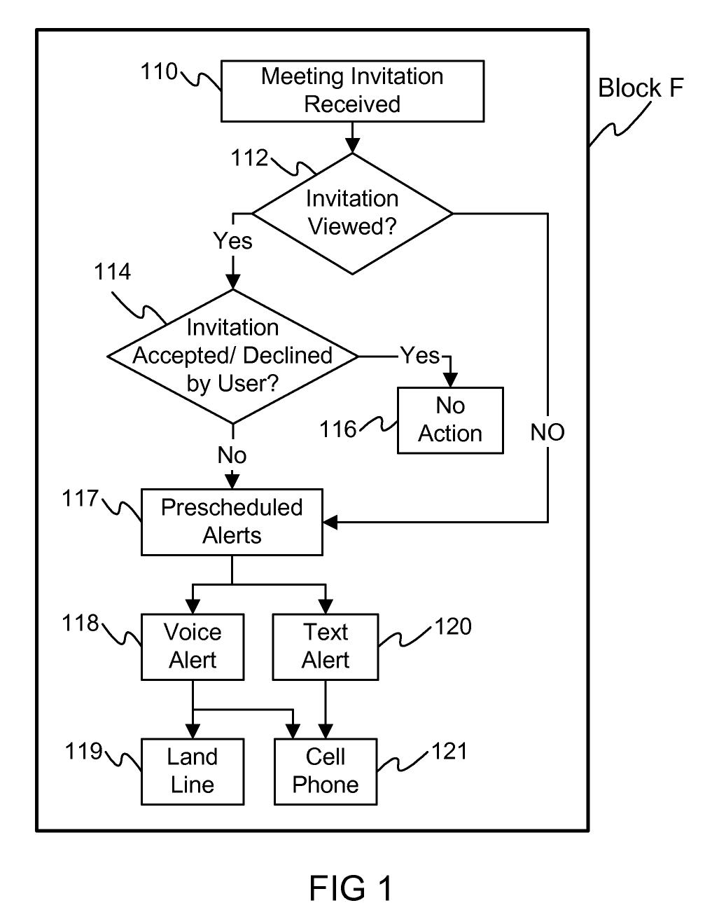

FIG. 1 illustrates the system in its generic form. The user can set predetermined alerts so that the system will send alerts in any and all combinations of an invitation. The user views the invitation (112, 114), he then can choose to configure the system to receive no further actions and turn the alarms off. (116) In case the user does not take any actions, (116) predetermined alarms that are set by the system will continue to alert the user via voice and text messages (118 and 120). The alerts can come inform the user via his cell phone or other communications devices such as handheld devices such as Research in Motion's BlackBerry.

FIG. 2 illustrates the flow of the system as an invitation is viewed by the user. The user also has the capability to set a predetermined alert so that an alert is sent to a regular land line telephone with a traditional ring, notifying the user of a pending meeting. (117-121)

A method to enhance current meeting and/or calendar programs such that a user receives alerts via cell and/or regular phone. Alerts may be, but are not limited to, specific ring tones, recorded messages, or text messages to a cell phone. (210, 212, 214, 216, 218) The meetings may require the user's physical presence or a teleconference. A program allows the user to enter configuration information specific to meetings posted to the user's calendar. An agent tracks each meeting invitation and initiates the alert based on the configured rules. In one embodiment of the invention, the user has accepted attendance to a meeting and configures the program to alert the user, for example, two hours prior to the meeting start. In another embodiment of the invention, the user has not accepted and/or is not aware of the proposed meeting, configures the program to alert the user, for example, three hours prior to the meeting start.

Below is another embodiment of the invention:

A method of configuring a meeting invitation notification for an unopened or unaccepted invitation in an electronic mail system, the method comprising the steps of:

a first entity receiving an electronic mail; (110)

wherein the electronic mail system comprising a notification module;

the first entity configuring the notification module;

wherein the notification module performing notification tasks based on predetermined rules;

wherein the notification tasks comprising a first notification task, a second notification task, a third notification task, a fourth notification task, and a fifth notification task;

wherein the electronic mail comprising an invitation for the first entity to a meeting, invited by a second entity;

if the first entity does not open the electronic mail, the notification module performing the first notification task;

if the first entity does not open the invitation, the notification module performing the second notification task;

if the first entity does not respond to the electronic mail, the notification module performing the third notification task;

if the first entity does not respond to the invitation, the notification module performing the fourth notification task; and

if the first entity responds to the invitation, the notification module performing the fifth notification task;

wherein the notification tasks comprising vibration alert, sound alert, music alert, voice alert, alarm alert, phone alert, electronic mail alert, repeated alert, random-timing alert, advanced alert based on a fixed-time period, display alert, vibrating mouse alert, text alert, fax alert, wire alert, Morse-code alert, ring-tone alert, and mass-notification alert.

A system, apparatus, or device comprising one of the following items is an example of the invention: meeting organizer, email server, server, client device, PDA, mobile device, cell phone, storage to store the messages, router, switches, network, communication media, cables, fiber optics, physical layer, buffer, nodes, packet switches, computer monitor, or any display device, applying the method mentioned above, for purpose of invitation or meeting management.

Any variations of the above teaching are also intended to be covered by this patent application.

1. A method of configuring a meeting invitation notification for an unopened or unaccepted invitation in a calendar system, said method comprising the steps of:
a first entity receiving a meeting invitation on said calendar system;
wherein said calendar system comprising a notification module;
said first entity configuring said notification module, said configuring including a period of time to notify said first entity prior to a meeting, for notification tasks;
wherein said notification module performs said notification tasks based on predetermined rules;
wherein said notification tasks comprise a first notification task, a second notification task, and a third notification task;
wherein said meeting invitation for said first entity to a meeting is initiated by a second entity;
an agent in said calendar system setting a flag for said meeting invitation to indicate not-opened status when said meeting invitation is initially received;
said agent keeping track of said meeting invitation, and setting said flag to indicate opened-invitation status when said first entity opens said meeting invitation;
based on said flag, if said first entity does not open said meeting invitation, said notification module performing said first notification task;
based on said flag, if said first entity does not respond to said meeting invitation, said notification module performing said second notification task;
based on said flag, if said first entity responds to said meeting invitation, said notification module performing said third notification task; and
said calendar system maintaining a log for said meeting invitation and status of said first entity corresponding to said meeting invitation.
